(19) United States
(12) Patent Application Publication
(10) Pub. No.: US 2025/0015544 A1
(43) Pub. Date: Jan. 9, 2025

(54) POLARIZIED QUICK PLUG HAVING REPLACEABLE FUSE

(71) Applicant: Guang Zhou Ting Shen Electric Co, Ltd., Guangzhou (CN)

(72) Inventor: Chia-Chun Wang, Guangzhou (CN)

(21) Appl. No.: 18/461,627

(22) Filed: Sep. 6, 2023

(30) Foreign Application Priority Data
Jul. 6, 2023 (CN) 2023108249115

(51) Int. Cl. H01R 13/688; H01R 4/2404; H01R 13/629

(52) U.S. Cl. CPC H01R 13/688; H01R 4/2404; H01R 13/629; H01R 13/52

(57) ABSTRACT

The present invention provides a polarized quick plug having replaceable fuse. The cable is fixed on the rear end of the inner seat by the breaking plates and the rear cover, so the inner seat has sufficient space to receive two fuses. The housing further has a window corresponding to the two fuses, and a movable plate is arranged at the window to selectively cover the window. The user can open the movable plate to exchange the working fuse and the spare fuse.

### FIELD OF THE INVENTION

The present disclosure relates to an electricity plug, more especially to a polarized quick plug having replaceable fuse.

### BACKGROUND OF THE INVENTION

A conventional electricity plug has a fuse and is capable of stripping. Chinese patent publication CN2233124Y disclosed an electricity plug having a socket, a fuse, an inner seat, and a housing. The plug is characterized in that the left insertion plate has a spike at an inner side, and that the spike is located at the left side of the cable receiving groove. The copper plate supporter receiving the fuse has a spike at the left side thereof, and the spike is located at the right side of the cable receiving groove. The two spikes correspond to and are connected to the cables at the left side and at the right side respectively. This kind of plug has only one fuse, and the fuse is unable to be quickly replaced if damaged. Besides, because an end of the cable is received in the plug composed of the housing and the inner seat, the cable is difficult to detach or install while maintenance or replacement. If the plug is fixed by glue or plastic material, the malfunction due to the cable contact problems may be unable to recover.

The present invention is, therefore, arisen to obviate or at least mitigate the above mentioned disadvantages.

### SUMMARY OF THE INVENTION

One of the objects of the present invention is to provide a polarized quick plug having replaceable fuse to receive one more spare fuse to improve the efficiency of maintenance. Also, the position of the cable is fixed, so the detachment and installation of the cable become easier.

To achieve the above and other objects, the polarized quick plug having replaceable fuse of the present invention includes an inner seat, a first plug plate assembly, a second plug plate assembly, and a housing. The first plug plate assembly and the second plug plate assembly are disposed on the inner seat. The housing covers the inner seat. The present invention is characterized by: the inner seat having a first slot and a second slot at two sides thereof respectively, the inner seat further having a first fuse room and a second fuse room at a left side and a right side of an intermediate portion of the inner seat; the first plug assembly including a first contact plate and a first breaking plate, the first slot including a front slot and a rear slot, an end of the first contact plate being inserted into the front slot, an opposite end of the first contact plate extending in front of the inner seat, an end of the first breaking plate being inserted into the rear slot, an opposite end of the first breaking plate extending behind the inner seat;

the second plug plate assembly including a second fixed plate inserted into the second slot, a second contact plate disposed on a front end of the second fixed plate and extending in front of the inner seat, and a second breaking plate disposed on a rear end of the second fixed plate and extending behind the inner seat; the inner seat having a groove for receiving a cable at a rear end thereof, the first breaking plate and the second breaking plate being arranged in the groove, a rear cover being disposed on the rear end of the inner seat to secure the cable; and the housing being formed with a window at positions corresponding to the first fuse groove and the second fuse groove, the housing further having a movable plate to selectively cover the window. In the present invention, two fuses are arranged in the plug wherein one of the fuses is for spare. If the working fuse is damaged, the user can open the movable plate to exchange the two fuses. Fuses are not common in a normal family, and the fuse is small to be difficult to find out. Thus, the present invention having two fuses in the plug is able to improve the maintenance efficiency. In addition, the cables are fixed at the rear end of the plug and secured by the rear cover, so the inner seat has much space to receive two fuses, and the cables are able to be detached or installed without removing the housing. Also, the water-proof processing of the inner seat becomes easier. While installing the cables, an end of the cable is placed into the groove, and the rear cover is installed so that the cable is pushed toward the breaking plate by the rear cover. The insulation layer of the cable is penetrated by the breaking plate so that the cable and the breaking plate are electrically connected. Thus, the cable has no need of stripping. The cable is substantially perpendicular to the plug plate so that the cable is difficult to separate from the plug even if the cable is pulled.

In some embodiments, the first slot is formed by a first wall and a first inner plate. The second slot is formed by a second wall and a second inner plate. The first inner plate has a first inclined guiding face at a top of a side thereof facing the first slot. The second inner plate has a second inclined guiding face at a top of a side thereof facing the second slot.

In some embodiments, an end of the first contact plate has a front contact portion which is bent and enters the first fuse groove. An end of the first breaking plate has a rear contact portion which is bent and enters the first fuse groove. A side of each of the front contact portion and the rear contact portion contacting the fuse has an arc contact face.

In some embodiments, each of the first breaking plate and the second breaking plate is triangle and is perpendicular to the rear terminal face of the inner seat. The first breaking plate and the second breaking plate are arranged staggeredly.

In some embodiments, the housing is formed with a receiving groove therein whose shape corresponds to a shape of the inner seat. The inner seat is received in the receiving groove. The inner seat and the housing are fixed together by glue or structural engagement.

In some embodiments, the housing has a sliding groove therein. The movable plate is slidably arranged in the sliding groove.

In some embodiments, the groove is formed by the rear terminal face of the inner seat and the housing. An inlet of the groove is located at a lateral face of the housing. The rear cover is slidable with respect to the housing. An inner side of the rear cover has a protruded portion for inserting into the groove. A partition rib is arranged on an intermediate portion of the protruded portion.

In some embodiments, the housing includes an upper cover plate, a lower cover plate, and lateral cover plates at two sides. Each of a rear end of the upper cover plate and the lower cover plate is protruded to form the sliding track. The rear cover has sliding pieces at two side thereof to cover the sliding tracks.

In some embodiments, the protruded portion has an inclined face at a front end thereof. The protruded portion further has a triangle stopping protrusion at a rear end thereof.

The present invention is more advantageous than prior arts in that:

1. Two fuses are set in the plug wherein one of the fuses is for spare. When the working fuse is damaged, the user can open the movable plate to exchange the two fuses. Fuses are not common in a normal family, and the fuse is too small to be difficult to find out. The present invention has two fuses in a plug so that the efficiency of maintenance is improved.

2. The cable is fixed at the rear end of the plug, so the inner seat has much space to receive two fuses.

3. The breaking plate is disposed on the rear end of the inner seat. That is, the cable is fixed at the rear end of the plug, and the cable is secured by the rear cover. Thus, the cable can be detached or installed without removing the housing. Also, the water-proof processing of the inner seat becomes easier. While installing the cable, an end of the cable is inserted into the groove for positioning, and the cable is further pushed toward the breaking plate by the rear cover. Thus, the breaking plate penetrates the insulation layer of the cable to electrically connect to the cable. Thereby, stripping of the cable is not necessary anymore.

4. The cable is substantially perpendicular to the plug plate, so the cable is difficult to separate from the plug even if being pulled.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

The present disclosure can be more fully understood by reading the following detailed description of the embodiment, with reference made to the accompanying drawings as follows:

FIG. 1 is a stereogram of the present invention;

FIG. 2 is a lateral view of the present invention;

FIG. 3 is a breakdown drawing of the present invention;

FIG. 4 is a profile of the present invention;

FIG. 5 is a top view of an inner seat of the present invention;

FIG. 6 is an illustration of a housing of the present invention;

FIG. 7 is an illustration showing a first plug plate assembly of the present invention;

FIG. 8 is an illustration showing a second plug plate assembly of the present invention;

FIG. 9 is an illustration showing a rear cover of the present invention.

### DETAILED DESCRIPTION OF THE PREFERRED EMBODIMENTS

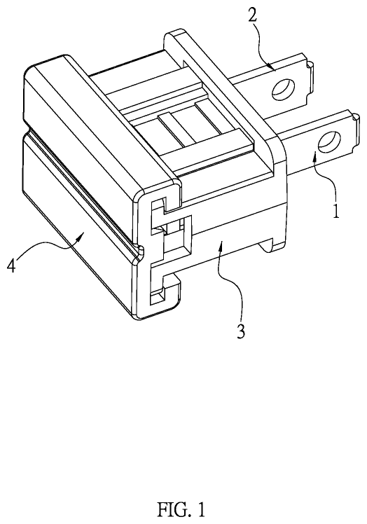

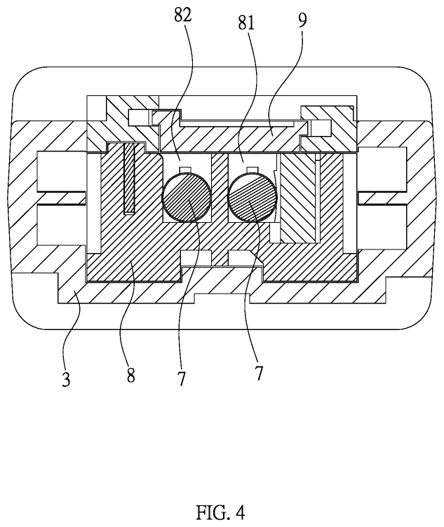

Please refer to FIG. 1 to FIG. 4, the polarized quick plug having replaceable fuse of the present invention includes an inner seat 8, a first plug plate assembly 1, a second plug plate assembly 2, a housing 3, and a rear cover 4. The first plug plate assembly 1 and the second plug plate assembly 2 are disposed on the inner seat 8. The housing 3 covers the inner seat 8. The rear cover 4 is disposed on the rear end of the housing 3 and is located behind the inner seat 8. The cable 6 is arranged between the rear cover 4 and the inner seat 8.

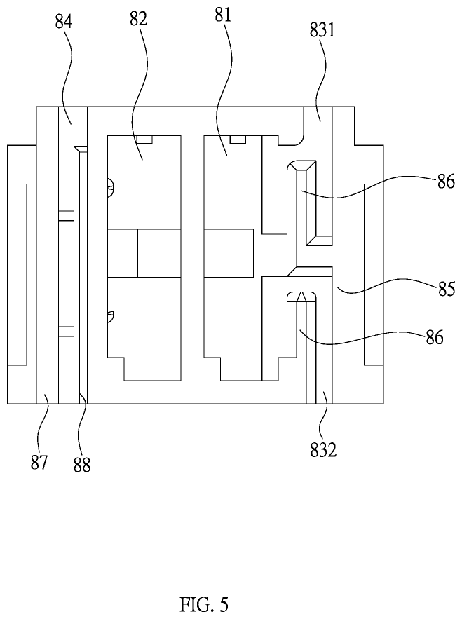

As shown in FIG. 5, the inner seat 8 has a first slot and a second slot 84 at two sides thereof respectively. The inner seat 8 further has a first fuse groove 81 and a second fuse groove 82 at an intermediate portion thereof wherein the first fuse groove 81 and the second fuse groove 82 are arranged at left side and right side respectively and are adapted for receiving fuses 7. The two fuse grooves 81, 82 are located between the two slots. The slots are substantially parallel to the fuse grooves. This arrangement is reasonable and is able to avoid the interference between the plug plate assemblies 1, 2 and the fuses 7. The plug plate assemblies and the fuses are installed along a vertical direction one by one. The fuse 7 in the first fuse groove 81 is the working fuse. The fuse 7 in the second fuse groove 82 is the spare fuse. The working fuse is electrically connected to the first plug plate assembly 1. The first slot includes a front slot 831 and a rear slot 832. The first slot is enclosed by a first wall 85 and a first inner plate 86. The second slot 84 is enclosed by a second wall 87 and a second inner plate 88. The first inner plate 86 has a first inclined guiding face at a top of a side thereof facing the first slot. The second inner plate 88 has a second inclined guiding face at a top of a side thereof facing the second slot 84. The guiding faces facilitate the installation of the plug plate assemblies. When the plug plate assemblies are installed, the top face of the plug plate assembly is flush with the top face of the inner plates. Thus, the plug plate assemblies can be pushed and fastened when the housing 3 is engaged with the inner seat 8.

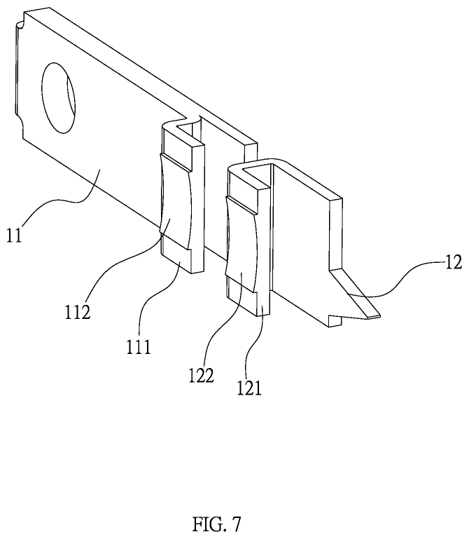

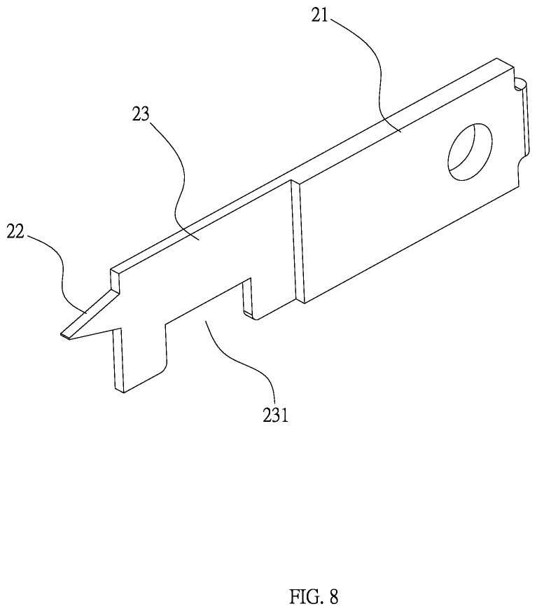

As shown in FIG. 7, the first plug plate assembly 1 includes a first contact plate 11 and a first breaking plate 12 which are copper plate respectively and formed by cutting and bending. An end of the first contact plate 11 is inserted into the front slot 831, and the other end of the first contact plate 11 extends in front of the rear end of the inner seat 8. An end of the first contact plate 11 is h-shaped, and an end of the first breaking plate 12 is L-shaped. The end of the first contact plate 11 has a bent front contact portion 111 for entering the first fuse groove 81. The end of the first breaking plate 12 has a bent rear contact portion 121 for entering the first fuse groove 81. The shapes can help fixation and electrical connection with the fuse. A side of each of the front contact portion 111 and the rear contact portion 121 contacting the fuse has an arc contact face 112,222. The arc contact faces 112,222 can increase the contact area to the fuse 7. As shown in FIG. 8, the second plug plate assembly 2 includes a second fixed plate 23 inserted into the second slot 84, a second contact plate 21 disposed on the front end of the second fixed plate 23 and extending in front of the inner seat 8, and a second breaking plate 22 disposed on the rear end of the second fixed plate 23 and extending behind the inner seat 8. The second fixed plate 23, the second contact plate 21, and the second breaking plate 22 are copper plates formed integrally and are shaped by cutting and bending. The second fixed plate 23 has a positioning groove 231 on the bottom thereof, and the second slot 84 has a positioning protrusion therein. When the second fixed plate 23 is inserted into the second slot 84, the positioning protrusion and the positioning groove are engaged together to prevent the second plug plate assembly 2 from moving and separating.

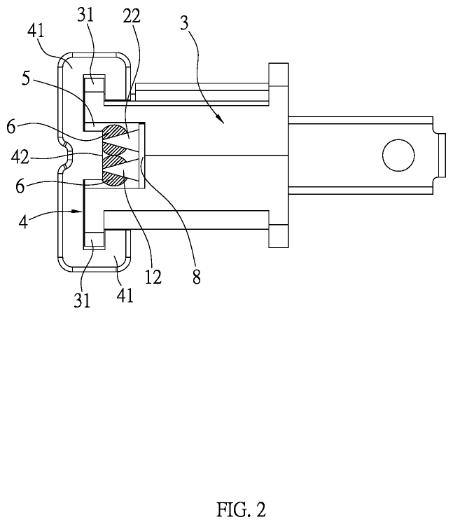

As shown in FIG. 2, the inner seat 8 has a groove 5 on the rear end thereof for receiving the cable 6. The first breaking plate 12 and the second breaking plate 22 are received in the groove 5 too. A rear cover 4 is disposed on the rear end of the inner seat 8 to push and fix the cable 6. Each of the first breaking plate 12 and the second breaking plate 22 is triangular and is perpendicular to the rear terminal face of the inner seat 8. The first breaking plate 12 and the second breaking plate 22 are arranged staggeredly to correspond to two parallel cables 6. The groove 5 is enclosed by the rear terminal face of the inner seat 8 and the housing 3. The groove 5 has an inlet 35 on the lateral face of the housing 3. The rear cover 4 is slidable with respect to the housing 3. The rear cover 4 slides to cover the groove 5 via the inlet 35 and pushes the cable 6 in the groove 5. The housing 3 includes an upper cover plate, a lower cover plate, and a lateral cover plate at two sides. The rear ends of the upper cover plate and the lower cover plate are protruded to form sliding tracks 31. The rear cover 4 is formed with sliding pieces 41 at two sides thereof to cover the sliding tracks 31. The connection between the sliding piece 41 and the sliding track 31 prevents the rear cover 4 from separating along the axial direction so that the rear cover 4 can press the cable 6 better.

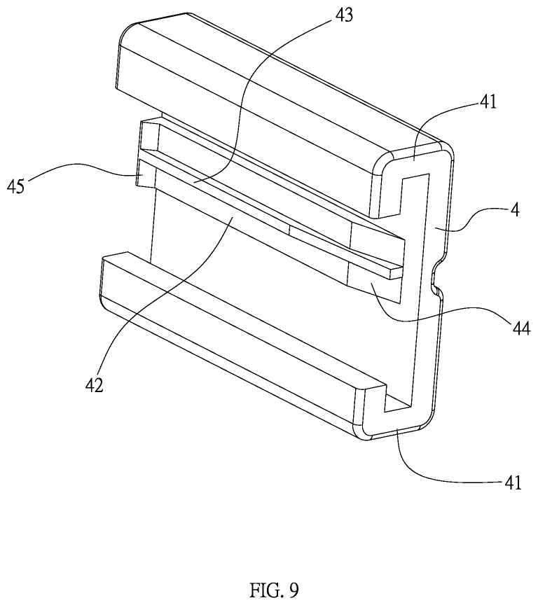

As shown in FIG. 9, the rear cover 4 has a protruded portion 42 therein to extend into the groove 5. The protruded portion 42 has a partition rib 43 at an intermediate portion thereof. The protruded portion 42 has an inclined face 44 at the front end thereof. The protruded portion 42 has a triangular stopping protrusion 45 at the rear end thereof. The inclined face 44 at the front end of the protruded portion 42 is able to reduce the force exerted onto the front end of the protruded portion 42 so that the rear cover 4 is easy to slide into the track. After the protruded portion 42 enters the groove 5, the protruded portion 42 can used to press the cable 6 tightly and makes the cable 6 move toward the breaking plate. Thus, the breaking plate is ensured to penetrate the insulation layer of the cable 6. When the rear cover 4 is sliding, the partition rib 43 is located between the two parallel cables 6 so that the positions of the two cables 6 may not deviate. After the sliding of the rear cover 4, the stopping protrusion 45 presses the cable 6 at the inlet 35. The cable 6 is prevented from separating from the groove 5 by the breaking plate and the stopping protrusion 45.

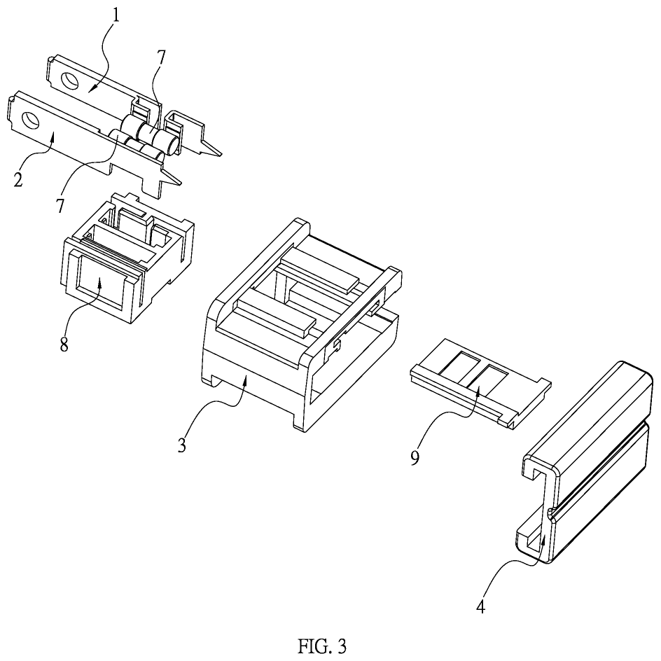

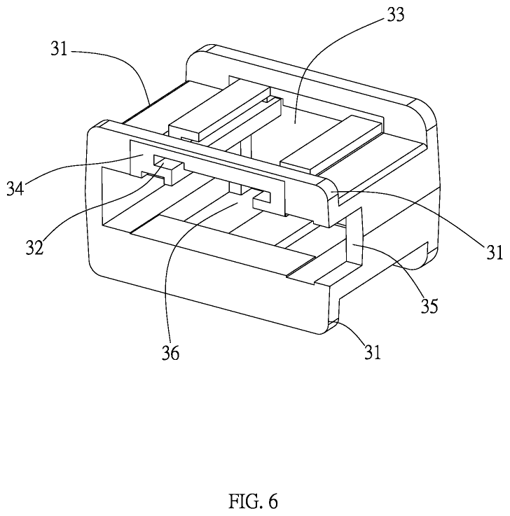

As shown in FIG. 3 and FIG. 6, the housing 3 has a receiving groove 36 therein whose shape corresponds to the shape of the inner seat 8. The inner seat 8 is received in the receiving groove 36. Practically, the inner seat 8 can enter the receiving groove 36 by sliding. To ensure the sliding of the inner seat smooth, sliding structures can be arranged on the bottom of the inner seat 8 and the housing 3, such as a sliding piece 41 and a sliding track. The upper cover plate of the housing 3 has a window 33 at the positioning corresponding to the first fuse groove 81 and the second fuse groove 82. A movable plate 9 is disposed on the housing 3 to selectively cover the window 33. To exchange the fuses 7 on the inner seat 8, the user can open the movable plate 9 to make the window 33 exposed. The upper cover plate of the housing 3 has a sliding groove 32 on the bottom thereof. The movable plate 9 and the sliding groove 32 are slidably connected. The movable plate 9 can slide into the sliding groove 32 via the front end or the rear end of the housing 3. When the movable plate 9 is set, the bottom of the sliding plate 9 contacts the top face of the inner seat 8.

In practice, the present invention can be processed by two ways. As shown in FIG. 6, the inner seat 8 and the housing 3 are fixed together by plastic injection. In this embodiment, the housing 3 can further include an upper cover 34, and the sliding groove for the movable plate 9 is formed on the upper cover 34. The upper cover 34 covers the top of the inner seat 8. In the second embodiment, the inner seat 8 and the housing 3 are fixed together by structural connection.

In use, one of the fuses 7 in the plug is a spare fuse. When the working fuse is damaged, the user can open the movable plate 9 to exchange the two fuses. Because fuses are not common in normal families, and the fuse is too small to be difficult to find out, the present invention with two fuses can improve the efficiency of maintenance. The cable 6 is fixed on the rear end of the plug, so the inner seat 8 has much space to receive two fuses. Besides, the cable 6 is fixed by the rear cover 4 at the rear end of the plug, so the cable 6 can be detached or installed without removing the housing 3. In addition, the processing of waterproof of the inner seat 8 becomes easier. When installing the cable 6, an end of the cable 6 is inserted into the groove 5 for positioning, and the rear cover 4 is installed to press the cable 6 toward the breaking plate. The breaking plate penetrates the insulation layer of the cable 6 to be electrically connected to the cable 6. Thus, stripping of the cable is not necessary anymore. When the cable 6 is installed, the cable 6 is perpendicular to the plug plate, so the cable 6 is prevented from separating from the plug even if the cable 6 is pulled.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A polarized quick plug having replaceable fuse, including an inner seat, a first plug plate assembly, a second plug plate assembly, and an housing, the first plug plate assembly and the second plug plate assembly being disposed on the inner seat, the housing covering the inner seat, characterized by:
the inner seat having a first slot and a second slot at two sides thereof respectively, the inner seat further having a first fuse room and a second fuse room at a left side and a right side of an intermediate portion of the inner seat;
the first plug assembly including a first contact plate and a first breaking plate, the first slot including a front slot and a rear slot, an end of the first contact plate being inserted into the front slot, an opposite end of the first contact plate extending in front of the inner seat, an end of the first breaking plate being inserted into the rear slot, an opposite end of the first breaking plate extending behind the inner seat;
the second plug plate assembly including a second fixed plate inserted into the second slot, a second contact plate disposed on a front end of the second fixed plate and extending in front of the inner seat, and a second breaking plate disposed on a rear end of the second fixed plate and extending behind the inner seat;
the inner seat having a groove for receiving a cable at a rear end thereof, the first breaking plate and the second breaking plate being arranged in the groove, a rear cover being disposed on the rear end of the inner seat to secure the cable;
the housing being formed with a window at position corresponding to the first fuse groove and the second fuse groove, the housing further having a movable plate to selectively cover the window.

2. The polarized quick plug having replaceable fuse of claim 1, wherein the first slot is formed by a first wall and a first inner plate, the second slot is formed by a second wall and a second inner plate, the first inner plate has a first inclined guiding face at a top of a side thereof facing the first slot, the second inner plate has a second inclined guiding face at a top of a side thereof facing the second slot.

3. The polarized quick plug having replaceable fuse of claim 1, wherein an end of the first contact plate has a front contact portion which is bent and enters the first fuse groove, an end of the first breaking plate has a rear contact portion which is bent and enters the first fuse groove, a side of each of the front contact portion and the rear contact portion contacting the fuse has an arc contact face.

4. The polarized quick plug having replaceable fuse of claim 1, wherein each of the first breaking plate and the second breaking plate is triangle and is perpendicular to the rear terminal face of the inner seat, the first breaking plate and the second breaking plate are arranged staggeredly.

5. The polarized quick plug having replaceable fuse of claim 1, wherein the housing is formed with a receiving groove therein whose shape corresponds to a shape of the inner seat, the inner seat is received in the receiving groove, the inner seat and the housing are fixed together by glue or structural engagement.

6. The polarized quick plug having replaceable fuse of claim 1, wherein the housing has a sliding groove therein, the movable plate is slidably arranged in the sliding groove.

7. The polarized quick plug having replaceable fuse of claim 1, wherein the groove is formed by the rear terminal face of the inner seat and the housing, an inlet of the groove is located at a lateral face of the housing, the rear cover is slidable with respect to the housing, an inner side of the rear cover has a protruded portion for inserting into the groove, a partition rib is arranged on an intermediate portion of the protruded portion.

8. The polarized quick plug having replaceable fuse of claim 7, wherein the housing includes an upper cover plate, a lower cover plate, and lateral cover plates at two sides, each of a rear end of the upper cover plate and the lower cover plate is protruded to form the sliding track, the rear cover has sliding pieces at two side thereof to cover the sliding tracks.

9. The polarized quick plug having replaceable fuse of claim 7, wherein the protruded portion has an inclined face at a front end thereof, the protruded portion further has a triangle stopping protrusion at a rear end thereof.
